(19) United States
(12) Patent Application Publication
(10) Pub. No.: US 2025/0106621 A1
(43) Pub. Date: Mar. 27, 2025

(54) SMART PHOTO FRAME THAT SUPPORTS SONIC WAVE CONFIGURATION FREE OF UNPACKING FOR GIFT GIVING

(71) Applicant: Beijing Cozyla Technology Ltd., Beijing (CN)

(72) Inventors: Ruiping Yin, Beijing (CN); Hongwei Gao, Beijing (CN); Kai Zhao, Beijing (CN)

(21) Appl. No.: 18/791,290

(22) Filed: Jul. 31, 2024

(30) Foreign Application Priority Data
Sep. 21, 2023 (CN) 202311221898.0

(51) Int. Cl. H04W 12/02

(52) U.S. Cl. CPC H04W 12/02

(57) ABSTRACT

This Invention involves the smart photo frame in technical field. Specifically, it relates to a smart photo frame that supports sonic wave configuration free of unpacking for gift giving. The smart photo frame comprises hardware components and a photo frame design, and the hardware components comprise a microphone capable of receiving ultrasonic waves, a network module, a storage device, a display, a processor, audio output devices, power supply components, operation keys, and a touch screen. The design of the photo frame includes 7 steps, and the specific steps will be discussed in detail thereinafter. This Invention is of wireless convenience, high efficiency and reliability by sonic wave configuration. And the smart photo frame is of comprehensive function, optimized user experience, and it can protect data security and personal privacy, improve the testing and evaluation, and provide an excellent product experience.

### CROSS-REFERENCE TO RELATED APPLICATIONS

This application claims priority of Chinese Patent Application No. 202311221898.0, filed on Sep. 21, 2023, the entire contents of which are incorporated herein by reference.

### TECHNICAL FIELD

This Invention involves the smart photo frame in technical field, Specifically, it relates to a smart photo frame that supports sonic wave configuration free of unpacking for gift giving.

### BACKGROUND TECHNOLOGY

The smart photo frame is a new generation product that integrates humanized and intelligence technology into traditional digital photo frames. The smart photo frame usually has the characteristics of large images, high clarity, convenient operation, and powerful functions. The intelligent development of photo frames includes two aspects: local intelligence and online intelligence. In addition to basic photo display functions, smart photo frames can also have other functions such as cloud storage and synchronization. Smart photo frames can save your photos in the cloud through cloud storage services and sync across multiple devices so that you can access your photos anytime, anywhere, and integrate your social media. Some smart Photo frames allow you to connect to social media platforms such as Google Photo, Instagram, etc., so that you can view and share your social media photos directly from the frame.

The steps of unpacking configuration or cable connection of existing smart photo frames are more complicated, there are hidden dangers in the information transmission and configuration between different devices, it is also true in data security and privacy protection, so we provide a smart photo frame supporting sonic wave configuration free of unpacking for gift giving to solve the above problems.

### CONTENT OF THE INVENTION

The objectives of the Invention are to provide a smart photo frame that supports sonic wave configuration free of unpacking for gift giving. The smart photo frame can provide excellent product experience with comprehensive functions such as wireless convenience, high efficiency and reliability, user experience optimization, protection of data security and personal privacy, testing and evaluation improvement.

The technical scheme adopted by the Invention is as follows:

The smart photo frame supporting sonic wave configuration free of unpacking for gift giving comprises hardware components and a photo frame design, and the hardware components comprise a microphone capable of receiving ultrasonic waves, a network module, a storage device, a display, a processor, audio output devices, power supply components, operation keys, and a touch screen.

In a preferred scheme, the design of the smart photo frame that supports sonic wave configuration free of unpacking for gift giving comprises the following steps:
Step 1: Determination of the functional requirements
Step 2: Configuration of sonic wave technology
Step 3: Design of configuration signals
Step 4: Development of configuration protocols
Step 5: Design of user interfaces
Step 6: Protection of security & privacy
Step 7: Testing and optimization

In a preferred scheme, the determination of functional requirements comprises determining the basic functions and additional advanced functions required for the smart photo frame, the basic functions include displaying photos, connecting to the Internet, and playing audio, and the advanced functions include voice control, face recognition, and intelligent recommendation.

In a preferred scheme, the sonic wave technology configuration comprises ultrasonic sonic wave technology, audio sonic wave technology and Bluetooth technology, the ultrasonic sonic wave technology is to utilize high-frequency sonic waves for information transmission, the audio sonic wave technology is to send and receive signals through the built-in speakers or external audio devices of the smart photo frame, and the Bluetooth technology is configured through Bluetooth wireless technology.

In a preferred scheme, the design of signal configuration comprises determining the frequency of the configuration signals, determining the duration of the configuration signals, selecting the encoding mode, optimizing the configuration signals. The frequency of the configuration signal to be determined is the frequency of the configuration signal to be used, and an appropriate frequency range is selected based on the selected sonic wave technology and device features. The duration of the configuration signal to be determined is the duration of the transmission signal. The duration depends on the communication distance, the ambient noise level and the device response time. The selection of encoding mode is to select an appropriate encoding mode to represent the configuration information, including binary encoding, frequency encoding and pulse encoding. The optimized configuration signal is to optimize the configuration signal through signal processing technology and algorithm. The signal processing technology and algorithm include error correction code and calibration.

In a preferred scheme, the development of configuration protocols comprises the message formats and communication flow of designing configuration protocols, the instruction sets and parameter definition of the determined configuration protocols, the design of the corresponding protocol extension and device identification mechanism. The communication flow comprises connection establishment, configuration request, configuration confirmation, configuration execution, configuration reply, and connection closure.

In a preferred scheme, the design of user interfaces comprises determining user needs and objectives, creating user portraits and user scenarios, formulating information architecture, designing high-fidelity prototype, and visual design of interfaces. The determination of user needs and objectives is to understand user needs and objectives, and collect user feedback, and conduct demand research and market data analysis. The creation of user portraits and user scenarios is to formulate the user scenarios based on the collected user information, and describe the typical scenarios when users use products or services. The development of information architecture is to develop a clear information architecture based on user needs and scenarios. The information architecture comprises a page structure, navigation components, a function classification. And the design of high-fidelity prototype involves using design tools to create specific styles, colors, fonts, and layouts for the interface. The visual design of the interface involves selecting suitable colors, icons, images, and layout based on a high-fidelity prototype.

In a preferred scenario, the security and privacy protections include the introduction of cryptographic algorithms and authentication mechanisms, the restriction of sensitive data transmission during the configuration process, so as to ensure identity verification and authorization mechanisms between the configuration process and device pairing.

In a preferred scheme, the test and optimization comprise the tests at different distances and noise environment scenarios, evaluating the configuration speed and reliability, collecting user feedback and data analysis, and improving the design and function.

The technical effects obtained by the Invention are as follows:

It is configured with sonic wave technology, there is no need to open the frame or use any data cable connection, the user can complete the configuration by putting the devices that need to send configuration signals close to the frame, and the operation is simple and convenient;

The smart photo frame provides basic features such as displaying photos, connecting to the Internet, and playing audio, while also providing advanced features such as voice control, face recognition, and intelligent recommendations to enhance user experience and functionality.

By designing the message format and communication process of the configuration protocols, the instruction sets and parameter definition of the configuration protocols are determined, and the efficiency and reliability of the configuration process are ensured.

The creation of user portraits and user scenarios is to formulate the information architecture and designing the high-fidelity prototype according to the user requirements and objectives so that the interface design can meet user expectations and habits, thereby providing a good user experience;

Encryption algorithms and authentication mechanisms are introduced to restrict the transmission of sensitive data during the configuration process, ensure the identity authentication and authorization mechanism between the configuration process and device pairing, and ensure the data security and privacy of users.

The configuration speed and reliability are evaluated by testing at different distances and in noisy environments, and user feedback and data analysis are collected to improve design and functionality and provide a better product experience.

### BRIEF DESCRIPTION OF THE DRAWINGS

FIG. 1 is a design schematic diagram of the smart photo frame that supports sonic wave configuration free of unpacking for gift giving.

### THE SPECIFIC IMPLEMENTATION MODE

In order to make the above-mentioned objectives, features and advantages of the Invention more obvious and easier to understand, the specific implementation mode of the Invention is described in detail below by combining with the drawings attached to the instructions.

### Case One

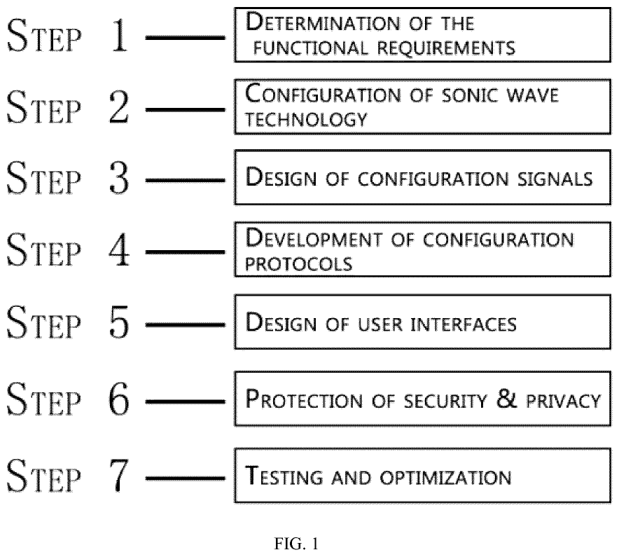

As shown in FIG. 1, the Invention provides a smart photo frame that supports sonic wave configuration free of unpacking for gift giving, the smart photo frame comprises hardware components and a photo frame design, and the hardware components comprise a microphone capable of receiving ultrasonic waves, a network module, a storage device, a display, a processor, audio output devices, power supply components, operation keys, and a touch screen.

The design of the smart photo frame that supports sonic wave configuration free of unpacking for gift giving comprises the following steps:

Step 1. Determination of the functional requirements: the determination of the functional requirements includes determining the basic functions and additional advanced functions required by the smart photo frame, the basic functions include displaying photos, connecting to the Internet, playing audio, and the advanced functions include voice control, face recognition, and intelligent recommendation;

Step 2. Configuration of sonic wave technology: the configuration of sonic wave technology is configured as audio sonic wave technology, and audio sonic wave technology is sent and received through the built-in speaker or external audio device of the smart photo frame;

Step 3. Design of configuration signals: the design of configuration signals comprises determining the frequency of the configuration signals, determining the duration of the configuration signals, selecting the coding mode, optimizing the configuration signals. The frequency of the configuration signal to be determined is the frequency of the configuration signal to be used, and an appropriate frequency range is selected based on the selected sonic wave technology and device features. The duration of the configuration signal to be determined is the duration of the transmission signal. The duration depends on the communication distance, the ambient noise level and the device response time. The selection of encoding mode is to select an appropriate encoding mode to represent the configuration information, including binary encoding, frequency encoding and pulse encoding. The optimized configuration signal is to optimize the configuration signal through signal processing technology and algorithm. The signal processing technology and algorithm include error correction code and calibration.

Step 4: Development of the configuration protocols: the development of configuration protocols comprises the message formats and communication flow of designing configuration protocols, the instruction sets and parameter definition of the determined configuration protocols, the design of the corresponding protocol extension and device identification mechanism. The communication flow comprises connection establishment, configuration request, configuration confirmation, configuration execution, configuration reply, and connection closure.

Step 5. Design of user interfaces: the design of user interfaces comprises determining user needs and objectives, creating user portraits and user scenarios, formulating information architecture, designing high-fidelity prototype, and visual design of interfaces. The determination of user needs and objectives is to understand user needs and objectives, collect user feedback, and conduct demand research and market data analysis. The creation of user portraits and user scenarios is to formulate the user scenarios based on the collected user information, and describe the typical scenarios when users use products or services. The development of information architecture is to develop a clear information architecture based on user needs and scenarios. The information architecture comprises a page structure, navigation components, a function classification. And the design of high-fidelity prototype involves using design tools to create specific styles, colors, fonts, and layouts for the interface. The visual design of the interface involves selecting suitable colors, icons, images, and layout based on a high-fidelity prototype.

Step 6: Protection of security and privacy: the protection of security and privacy includes the introduction of encryption algorithms and authentication mechanisms, restricting the transmission of sensitive data during the configuration process, and ensuring identity verification and authorization mechanism between the configuration process and device pairing;

Step 7. Testing and optimization: the testing and optimization includes testing at different distances and noise environment scenarios, evaluating configuration speed and reliability, collecting user feedback and data analysis, and improving design and functionality.

### Case Two

As shown in FIG. 1, the Invention provides a smart photo frame that supports sonic wave configuration free of unpacking for gift giving. The smart photo frame comprises hardware components and a photo frame design, and the hardware components comprise a microphone capable of receiving ultrasonic waves, a network module, a storage device, a display, a processor, audio output devices, power supply components, operation keys, and a touch screen.

The design of a smart photo frame that supports sonic wave configuration free of unpacking for gift giving comprises the following steps:

Step 1. Determination of the functional requirements: the determination of the functional requirements includes determining the basic functions and additional advanced functions required by the smart photo frame, the basic functions include displaying photos, connecting to the Internet, playing audio, and the advanced functions include voice control, face recognition, and intelligent recommendation;

Step 2: Sonic wave technology configuration: sonic wave technology is configured with ultrasonic sonic wave technology, the ultrasonic sonic wave technology conducts information transmission by the use of high-frequency sonic wave;

Step 3. Design of configuration signals: the design of configuration signals comprises determining the frequency of the configuration signal, determining the duration of the configuration signal, selecting the encoding mode, optimizing the configuration signal. The determining of the frequency of the configuration signal is determining the frequency of the configuration signal to be used, selecting a suitable frequency range according to the features of the selected sonic wave technology and equipment. The determining of the duration of the configuration signal is determining the duration of the sending signal, and the duration depends on the communication distance, environmental noise level and device response time. The selection of encoding mode is to select an appropriate encoding mode to represent the configuration information, including binary encoding, frequency encoding and pulse encoding. The optimized configuration signal is to optimize the configuration signal through signal processing technology and algorithm. The signal processing technology and algorithm include error correction code and calibration.

Step 4: Development of configuration protocols: the development of the configuration protocols comprises designing a message format and a communication flow of the configuration protocols, determining the instruction sets and parameter definition of the configuration protocols, designing a corresponding protocol extension and a device identification mechanism, and the communication flow comprises connection establishment, configuration request, configuration confirmation, configuration execution, configuration response, and connection closure;

Step 5. User interface design, user interface design includes determining user needs and goals, creating user portraits and user scenarios, formulating information architecture, designing high-fidelity prototype, visual design of interfaces, determining user needs and goals to understand user needs and goals, and collecting user feedback, Demand research and market analysis data, create user portraits and user scenarios based on the collected user information, create user portraits, develop user scenarios, describe typical scenarios of users in the specific use of products or services, develop information architecture based on user needs and scenarios, develop a clear information architecture, information architecture includes page structure, navigation components, functional classification, high-fidelity prototyping to create specific styles, colors, fonts and layouts, the visual design of the interface is based on high-fidelity prototypes to choose suitable colors, icons, pictures and typography;

Step 6: Security and privacy protection, which includes the introduction of encryption algorithms and authentication mechanisms, restricting the transmission of sensitive data during the configuration process, and ensuring authentication and authorization mechanisms between the configuration process and device pairing;

Step 7. Testing and optimization: testing and optimization include testing at different distances and noise environment scenarios, evaluating configuration speed and reliability, collecting user feedback and data analysis, and improving design and functionality.

### Case Three

As shown in FIG. 1, the Invention provides a smart photo frame supporting sonic wave configuration free of unpacking for gift giving. The smart photo frame comprises hardware components and a photo frame design, and the hardware components comprise a microphone capable of receiving ultrasonic waves, a network module, a storage device, a display, a processor, audio output devices, power supply components, operation keys, and a touch screen.

The design of a smart photo frame that supporting sonic wave configuration free of unpacking for gift giving comprises the following steps:

Step 1. Determination of the functional requirements: the determination of the functional requirements includes determining the basic functions and additional advanced functions required by the smart photo frame, the basic functions include displaying photos, connecting to the Internet, playing audio, and the advanced functions include voice control, face recognition, and intelligent recommendation;

Step 2. Configuration of sonic wave technology: the configuration of sonic wave technology is configured with Bluetooth technology, and Bluetooth technology is configured through Bluetooth wireless technology;

Step 3. Design of configuration signals: the design of configuration signals includes determining the frequency of the configuration signals, determining the duration of the configuration signals, selecting the encoding mode, and optimizing the configuration signals. The frequency of the configuration signal to be determined is the frequency of the configuration signal to be used, and an appropriate frequency range is selected based on the selected sonic wave technology and device features. The duration of the configuration signal to be determined is the duration of the transmission signal. The duration depends on the communication distance, the ambient noise level and the device response time. The selection of encoding mode is to select an appropriate encoding mode to represent the configuration information, including binary encoding, frequency encoding and pulse encoding. The optimized configuration signal is to optimize the configuration signal through signal processing technology and algorithm. The signal processing technology and algorithm include error correction code and calibration.

Step 4: Development of configuration protocols: the development of configuration protocols comprises designing the message formats and communication flow of configuration protocols, determining the instruction sets and parameter definition of the configuration protocols, designing the corresponding protocol extension and device identification mechanism. The communication flow comprises connection establishment, configuration request, configuration confirmation, configuration execution, configuration reply, and connection closure.

Step 5. Design of user interface: the design of user interfaces comprises determining user needs and objectives, creating user portraits and user scenarios, formulating information architecture, designing high-fidelity prototype, and visual design of interfaces. The determination of user needs and objectives is to understand user needs and objectives, and collect user feedback, and conduct demand research and market data analysis. The creation of user portraits and user scenarios is to formulate the user scenarios based on the collected user information, and describe the typical scenarios when users use products or services. The development of information architecture is to develop a clear information architecture based on user needs and scenarios. The information architecture comprises a page structure, navigation components, a function classification. And the high-fidelity prototyping design involves using design tools to create specific styles, colors, fonts, and layouts for the interface. The visual design of the interface involves selecting suitable colors, icons, images, and layout based on the high-fidelity prototype.

Step 6: Protection of security and privacy: the protection of security and privacy includes the introduction of encryption algorithms and authentication mechanisms, restricting the transmission of sensitive data during the configuration process, and ensuring identity verification and authorization mechanisms between the configuration process and device pairing;

Step 7. Testing and optimization: the testing and optimization include testing at different distances and noise environment scenarios, evaluating configuration speed and reliability, collecting user feedback and data analysis, and improving design and functionality.

In the Invention, the configuration is carried out through the sonic wave technology. There is no need to open the frame or use any data cable connection, the user can complete the configuration by putting the devices that need to send configuration signals close to the frame, and the operation is simple and convenient. The smart photo frame has the basic functions such as displaying photos, connecting to the Internet and playing audio, and also provides advanced functions such as voice control, face recognition and intelligent recommendation, thereby enhancing the user experience and functionality. Through the design of the message format and communication flow of the configuration protocols, the instruction sets and parameter definition of the configuration protocols are determined to ensure the efficiency and reliability of the configuration process. The creation of user portraits and user scenarios is to formulate the information architecture and design the high-fidelity prototype according to the user needs and objectives so that the interface design can meet user expectations and habits, thereby providing a good user experience. The introduction of encryption algorithms and authentication mechanisms restricts the transmission of sensitive data during the configuration process, and ensures identity verification and authorization mechanisms between the configuration process and device pairing; thereby ensuring the user's data security and privacy. The testing is conducted at different distances, and in noisy environments to evaluate configuration speed and reliability, collect user feedback and data analysis, improve design and functionality and provide a better product experience.

The above mentioned is only the preferred implementation modes in this Invention, and it should be noted that for an ordinary technician in the technical field, a number of improvements and refinements can also be made under the premise without departing from the principles of the Invention, and these improvements and refinements shall also be considered as the scope of protection of the Invention. The structure, device and implementation modes not specifically described and explained in the Invention are carried out in accordance with the conventional modes in the field unless otherwise specified and limited.

1. The smart photo frame that supports sonic wave configuration free of unpacking for gift giving is characterized as follows: the smart photo frame comprises hardware components and a photo frame design, and the hardware components comprise a microphone capable of receiving ultrasonic waves, a network module, a storage device, a display, a processor, audio output devices, power supply components, operation keys, and a touch screen.

2. The smart photo frame supporting sonic wave configuration free of unpacking for gift giving mentioned in claim 1 is characterized as follows, and the design of the photo frame comprises the following steps:
Step 1: determination of the functional requirements;
Step 2: configuration of sonic wave technology;
Step 3: design of configuration signals;
Step 4: development of configuration protocols;
Step 5: design of user interfaces;
Step 6: protection of security & privacy;
Step 7: testing and optimization.

3. The smart photo frame supporting sonic wave configuration free of unpacking for gift giving mentioned in claim 2 is characterized as follows: the determination of function requirements includes the basic functions and additional advanced functions required to determine the smart photo frame; the basic functions include displaying photos, connecting to the Internet, and playing audio; the additional advanced functions include voice control, face recognition, and intelligent recommendation.

4. The smart photo frame supporting sonic wave configuration free of unpacking for gift giving mentioned in claim 2 is characterized as follows: the configuration of the sonic wave technology includes ultrasonic sonic wave technology, audio sonic wave technology, and Bluetooth technology; the ultrasonic sonic wave technology uses high-frequency sonic waves for information transmission, the audio sonic wave technology sends and receives signals through the built-in speakers or external audio devices of the smart photo frame, and the Bluetooth technology is configured through Bluetooth wireless technology.

5. The smart photo frame supporting sonic wave configuration free of unpacking for gift giving mentioned in claim 2 is characterized as follows: the design configuration and signal configuration include determining the frequency of the configuration signals, determining the duration of the configuration signals, selecting the encoding mode, and optimizing the configuration signals; the frequency of the configuration signal to be determined is the frequency of the configuration signal to be used, and an appropriate frequency range is selected based on the selected sonic wave technology and device features; the duration of the configuration signal to be determined is the duration of the transmission signals; the duration depends on the communication distance, the ambient noise level and the device response time; the selection of encoding mode is to select an appropriate encoding mode to represent the configuration information, including binary encoding, frequency encoding and pulse encoding; the optimized configuration signal is to optimize the configuration signals through signal processing technology and algorithm; the signal processing technology and algorithm include error correction code and calibration.

6. The smart photo frame supporting sonic wave configuration free of unpacking for gift giving mentioned in claim 2 is characterized as follows: the development of configuration protocols comprises the message formats and communication flow of designing configuration protocols, the instruction sets and parameter definition of the determined configuration protocols, the design of the corresponding protocol extension and device identification mechanism; the communication flow comprises connection establishment, configuration request, configuration confirmation, configuration execution, configuration reply, and connection closure.

7. The smart photo frame supporting sonic wave configuration free of unpacking for gift giving mentioned in claim 2 is characterized as follows: the design of user interfaces comprises determining user needs and objectives, creating user portraits and user scenarios, formulating information architecture, designing high-fidelity prototype, and visual design of interfaces; the determination of user needs and objectives is to understand user needs and objectives, and collect user feedback, and conduct demand research and market data analysis; the creation of user portraits and user scenarios is to formulate the user scenarios based on the collected user information, and describe the typical scenarios when users use products or services; the development of information architecture is to develop a clear information architecture based on user needs and scenarios; the information architecture comprises a page structure, navigation components, a function classification; and the design of high-fidelity prototype involves using design tools to create specific styles, colors, fonts, and layouts for the interface; the visual design of the interface involves selecting suitable colors, icons, images, and layout based on a high-fidelity prototype.

8. The smart photo frame supporting sonic wave configuration free of unpacking for gift giving mentioned in claim 2 is characterized as follows: the protection of security and privacy includes introducing encryption algorithms and authentication mechanisms, restricting sensitive data transmission during the configuration process so as to ensure identity verification and authorization mechanisms between the configuration process and device pairing.

9. The smart photo frame supporting sonic wave configuration free of unpacking for gift giving mentioned in claim 2 is characterized as follows: the testing and optimization comprise the tests at different distances and noise environment scenarios, evaluating the configuration speed and reliability, collecting user feedback and data analysis, and improving the design and function.
